(19) United States
(12) Patent Application Publication
(10) Pub. No.: US 2012/0105719 A1
(43) Pub. Date: May 3, 2012

(54) SPEECH SUBSTITUTION OF A REAL-TIME MULTIMEDIA PRESENTATION

(75) Inventors: Roger A. Fratti, County of Berks, PA (US); Cathy L. Hollien, County of Somerset, NJ (US)

(73) Assignee: LSI Corporation, Milpitas, CA (US)

(21) Appl. No.: 12/915,089

(22) Filed: Oct. 29, 2010

(51) Int. Cl. H04N 7/00; G06F 17/28

(52) U.S. Cl. 348/462; 704/2; 704/E11.001; 348/E07.001

(57) ABSTRACT

Disclosed are a method, an apparatus and/or system of speech substitution of a real-time multimedia presentation on an output device. In one embodiment, a method includes processing a multimedia signal of a multimedia presentation, using a processor. The multimedia signal includes a video signal and an audio signal, such that the audio signal is substitutable with another audio signal based on a preference of a user. The method also includes substituting the audio signal with another audio signal based on the preference of the user. Additionally, the method includes permitting a selection of a voice profile during a real-time event based on a response to a request through a client device of the user.

### FIELD OF TECHNOLOGY

This disclosure relates generally to a signal processing and, more particularly, to speech substitution of a real-time multimedia presentation.

### BACKGROUND

When viewing a multimedia presentation of a real-time event (e.g., a newscast, a sporting event) on an output device (e.g., a television), a user may prefer a different audio component (e.g., the speech) of the multimedia presentation. For example, the user may prefer a particular commentator of the sporting event. In response, the user may mute the audio component of the sporting event while watching the sporting event. A problem with this approach may be that all of the other background noise (e.g., cheering fans) is muted, too

In another example, the user may have difficulty understanding a newscast, because the newscast may be in a language foreign to the user. In response, the user may read a closed caption of the newscast in a language familiar to the user. A problem with this approach may be that reading the closed caption may take away from the experience of watching the newscast. As a result, the user may have a diminished experience when viewing the multimedia presentation of the real-time event.

### SUMMARY

Disclosed are a method, an apparatus and/or a system of speech substitution of a real-time multimedia presentation on an output device.

In one aspect, a method includes processing a multimedia signal of a multimedia presentation using a processor. The multimedia signal includes a video signal and an audio signal, such that the audio signal is substitutable with another audio signal based on a preference of a user. The method also includes substituting the audio signal with another audio signal based on the preference of the user. In addition, the method includes permitting a selection of a voice profile during a real-time event based on a response to a request through a client device of the user. The method also includes creating another audio signal based on the voice profile. The voice profile is selected by the user. The method further includes delaying an output of the video signal to an output device of the user such that the video signal is synchronized with another audio signal. The method also includes processing the video signal and another audio signal based on the voice profile such that the multimedia presentation is created based on the preference of the user.

In another aspect, a method includes obtaining video data together with first audio data. The first audio data may include an original speech data. The method also includes converting the original speech data to text data. In addition, the method includes converting the text data to user-selected speech data. The method also includes combining a video data together with the user-selected speech data. The method further includes providing the video data together with second audio data to be presented to a user. The second audio data includes the user-selected speech data in place of the original speech data. The aforementioned conversion, combination, and providing operation are performed using the processor and without human intervention

In yet another aspect, a system includes an output device to display a multimedia presentation and a processor to process a multimedia signal of the multimedia presentation. The multimedia signal includes a video signal and an audio signal, such that the audio signal can be substituted with another audio signal based on a preference of a user. The system also includes a client device to permit a selection of a voice profile during a real-time event such that another audio signal is based on the voice profile.

The methods, systems, and apparatuses disclosed herein may be implemented in any means for achieving various aspects. Other features will be apparent from the accompanying drawings and from the detailed description that follows.

### BRIEF DESCRIPTION OF THE VIEWS OF DRAWINGS

Example embodiments are illustrated by way of example and not limitation in the figures of the accompanying drawings, in which like references indicate similar elements and in which:

FIG. 1 is a schematic view illustrating an implementation of a speech replacement module in a system, according to one or more embodiments.

FIG. 2 is an exploded view of the speech replacement module, according to one or more embodiments.

FIG. 3 is a schematic view illustrating a modified Transport stream-System Target Decoder (T-STD), according to one example embodiment.

FIG. 4 is a schematic view of speech-text converter, according to one or more embodiments.

FIG. 5 is a table view illustrating a portion of a database of speech, according to one example embodiment.

FIG. 6 is a user interface view illustrating a choice of voice substitutions being provided to a user in a client device, according to one or more embodiments.

FIG. 7 is a flow diagram detailing operations involved in speech substitution of a real-time multimedia presentation, according to one or more embodiments.

FIGS. 8A, 8B, and 8C are schematic views illustrating substitution of an audio signal, according to an example embodiment.

Other features of the present embodiments will be apparent from the accompanying drawings and from the detailed description that follows.

### DETAILED DESCRIPTION

Disclosed are a method, an apparatus and/or system of speech substitution of a real-time multimedia presentation on an output device. Although the present embodiments have been described with reference to specific example embodiments, it will be evident that various modifications and changes may be made to these embodiments without departing from the broader spirit and scope of the various embodiments.

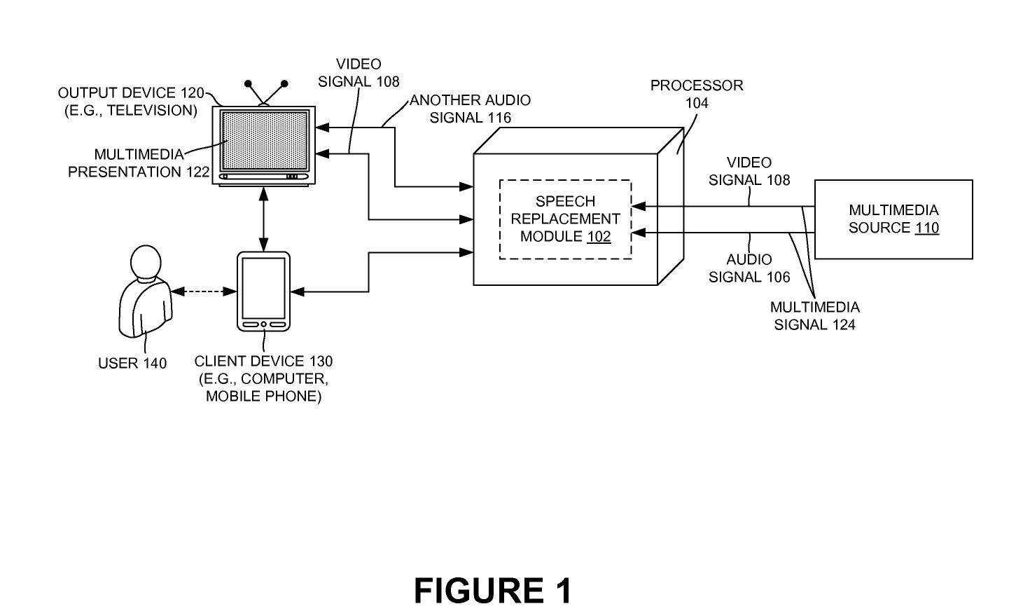

FIG. 1 is a schematic view illustrating an implementation of a speech replacement module 102 in a system, according to one or more embodiments. The system may include a processor 104 configured to be communicatively coupled to client device(s) 130, an output device 120 and a multimedia source 110. The client device 130 may be any device capable of communicating with a processor 104. In one or more embodiments, the client device 130 may include, but is not limited to a computer, a mobile phone, and a set-top box. The output device 120 may be device such as a digital television configured to output (or present) a multimedia presentation 122. In some embodiment, the client device 130 may also be an output device.

The output device 120 as described herein may include audio output hardware (e.g., speakers, microphones), a video output hardware (e.g., a display), and necessary software to present the multimedia presentation 122. The multimedia presentation 122 may be a real-time event such as, for example, a sporting event or a newscast presented through an output device 120 or the client device 130. The multimedia presentation 122 as described may be received by the output device 120 or the client device 130 from the multimedia source 110 through the processor 104.

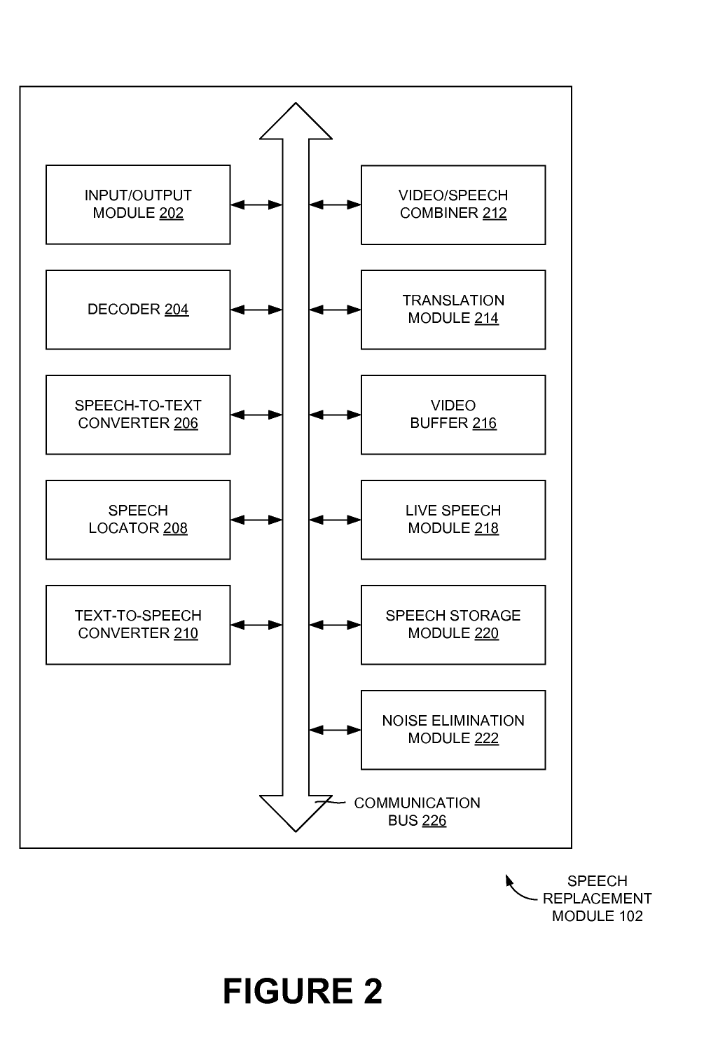

According to one embodiment, a multimedia signal 124 communicated to the output device 120 may be processed by the processor 104. The multimedia signal 124 may include an audio signal 106 and a video signal 108. The video signal 108 may include a video component of the multimedia signal 124 and the audio signal 106 may include a voice component of the multimedia signal 124. The processor 104 may include the speech replacement module 102 configured to perform replacement of an original audio component of the audio signal 106 with another audio signal 116, perform translation of a speech, perform speech to text conversion, and/or generate another audio signal 116 based on a preference of the user 140. In one embodiment, the processor 104 may be a multimedia processor configured for broadcasting and/or streaming multimedia content to the output device 120. In alternate embodiments, the processor 104 may also be a web processor configured for providing multimedia presentations to the output device 120 when requested. The processor 104 may include one or more processors, storage devices, a speech replacement module 102, digital signal processing circuits and supporting software for performing operations such voice replacement, speech-to text conversion, translation, noise cancellation, video/speech combination, and/or providing live speech. The speech replacement module 102 is described in FIG. 2.

In one embodiment, the multimedia presentation 122 may be presented on the output device 120 and/or the client device 130. The user 140 of the output device 120 and/or the client device 130 may communicate a request to the processor 104 through the client device 130 to change features of the multimedia presentation 122 (e.g., voice, language). In one embodiment, the user 140 may communicate a request by the client device 130. For example, user 140 may use a cell phone (e.g., client device) to communicate a request. In another example, the user 140 may use a remote control device to communicate a request to the processor 104 through the set-top box. The request may be received by the processor 104 and a response may be communicated back to the client device 130 and displayed on the display of the client device 130 and/or on the output device 120. The response may be options for changing features of the multimedia presentation 122. The response may include options such as, but not limited to, change in voice, change in language, and change in text. The choice of the user 140 may be communicated to the processor 104 through the client device 130. The response may be obtained and presented as a modified multimedia presentation 122 based on the preference and/or the request of the user 140.

In another embodiment, the processor 104 may be incorporated within the output device 120. The user 140 may select a different voice profile through the client device 130. The client device 130 may be a remote control and the user 140 may choose the voice profile through a user interface 650 that is displayable on the output device 120.

FIG. 2 is an exploded view of the speech replacement module 102, according to one or more embodiments. Particularly, the speech replacement module 102 of the of FIG. 2 illustrates an input/output module 202, a decoder 204, a speech-to-text converter 206, a speech locator 208, a text-to-speech converter 210, a video/speech combiner 212, a translation module 214, a video buffer 216, a live speech module 218, a speech storage module 220 and a noise elimination module 222, according to one embodiment.

The input/output module 202 may be an interface configured to receive and communicate multimedia signals, and receive user requests. In one embodiment, the input/output module 202 may be configured to receive the multimedia signal 124 from the multimedia source 110 and command signals from the client device 130. In one embodiment, the received multimedia signal 124 may be an original Audio-Visual (AV) signal carrying a multimedia content. The received multimedia signal 124 may be processed by the speech replacement module 102 based on a user preference to provide a modified multimedia signal (e.g., another audio signal 116) to be presented in the client device 130.

The decoder 204 of the speech replacement module 102 may be used for decoding the multimedia signal 124. In one embodiment, a speech component in the audio signal 106 may be extracted. The extracted speech component may be used by one or more modules, for example, the speech-to-text converter 206, the translation module 214, and the like, to process the extracted multimedia signal 124. In one or more embodiments, the processing of the decoded multimedia signal may be based on the user 140 request.

The speech-to-text converter 206 of the speech replacement module 102 may be a module configured to generate a transcript based on a speech component of an audio component of the multimedia signal. The speech-to-text converter 206 may be a real-time speech-to-text conversion module that uses the extracted speech component of the audio signal 106 to generate a text data. The speech-to-text converter 206 may include other modules to sense accents in the audio to be converted into a text.

The noise elimination module 222 may be a module configured to isolate noise (e.g., cheering fans noise background) from the original audio signal 106. The text-to-speech converter 210 may implement a speech synthesis process to generate artificial human speech based on the text or the transcript. In one embodiment, a text-to-speech converter 210 may convert text to user-selected speech based on the text file and the voice profile selected by the user 140. In some embodiments, the text-to-speech converter 210 may be a configured to render symbolic linguistic representations such as phonetic transcriptions into speech signal. Also, in some other embodiments, synthesized speech may be generated by concatenating pieces of recorded speech of a voice profile stored in a database. The database may include one or more recorded voice profiles. In one embodiment, the voice profile may be a preprogrammed voice font. The voice font may include a library of a speech. The library of the speech may include a canned speech, a part of the speech of an individual of the voice profile, the speech of an impersonator of the individual of the voice profile, and/or the speech of a live commentator.

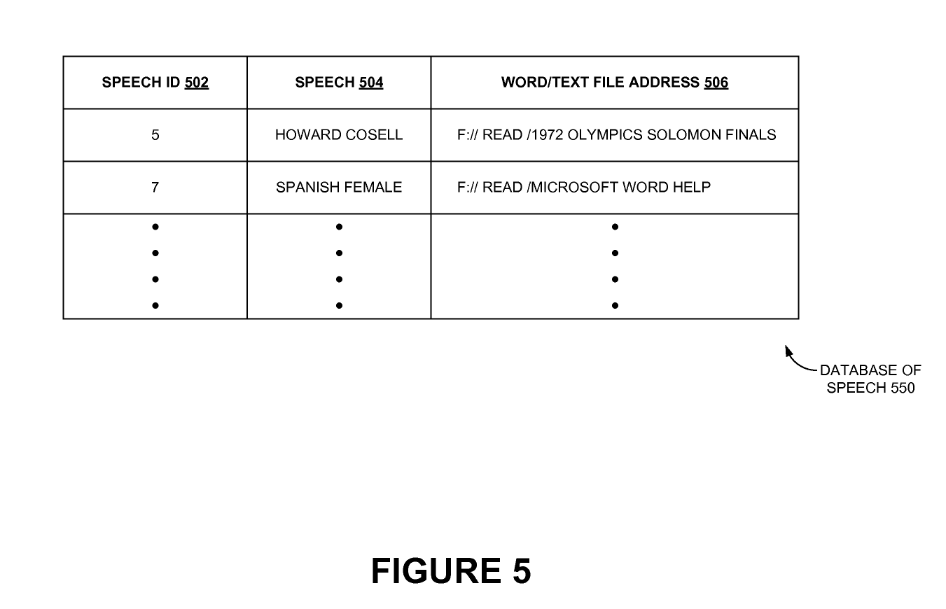

The database may be maintained by the speech storage module 220. In one or more embodiments, the speech storage module 220 may be configured to utilize storage device(s) in the processor 104 to store voice profiles in the database. An example table view of a database illustrating a mapping of speech information is provided in the FIG. 5.

The translation module 214 of the speech replacement module 102 may be configured to perform translation of the transcript generated by the speech-to-text converter 206 in one language to another language as requested by the user when voice profile selected would be of a foreign language speaker. The translated transcript may be provided to the text-to-speech converter to convert the text into an artificial human speech to be merged into the audio signal 106.

The live speech module 218 may be a module configured to provide direct speech substitution/replacement to the speech component in the audio signal 106. In one embodiment, there may be a pre-recorded version of speech data in the database of the speech storage module 220 for substituting the original speech in the audio signal 106. In one example embodiment, the news may be provided in English. However, the user may prefer to listen to the news in Spanish language. The user may request the news in Spanish language. Accordingly, the speech replacement module 102 of the processor 104 may generate the news in Spanish and the news in Spanish may be presented. The stored voice profiles and/or the live speeches in the database of the speech storage module 220 may be located through the speech locator 208 of the speech replacement module 102.

Each of the operations speech-to-text conversion, translation, speech substitution, speech replacement, text-to-speech conversion, merging the speech element to the audio signal 106 and/or synchronizing with the video signal 108 may require some duration of time. In one embodiment, the video signal 108 may have to be delayed such that the aforementioned operations are completed during a delay of the video signal 108.

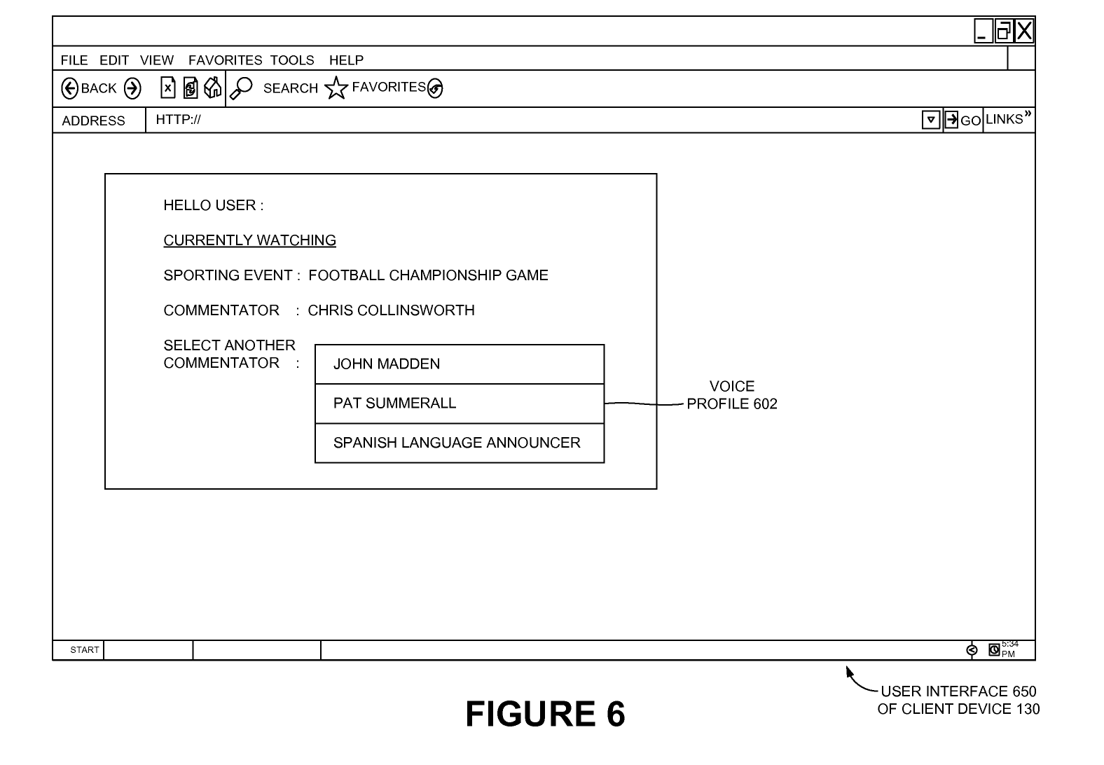

The speech replacement module 102 may also include a video buffer 216 to delay the video signal 108 for the duration of time until another audio signal 116 (e.g., the modified audio signal) can be generated to be synchronized with the video signal 108. Another audio signal 116 may be real-time audio signal, a pre-recorded audio signal or a combination of thereof, according to one or more embodiments. As another audio signal 116 is generated, the video signal 108 may be synchronized with another audio signal 116 and communicated to the video/speech combiner 212. The video/speech combiner 212 may perform audio and video combination and synchronization to be communicated to the output device 120. The final generated signal may be communicated to the output device 120 through the input/output module 202. The communications in the speech replacement module 102 may be enabled through a communication bus 226 provided thereof. An operation of the speech replacement module 102 is explained with an example in FIG. 6.

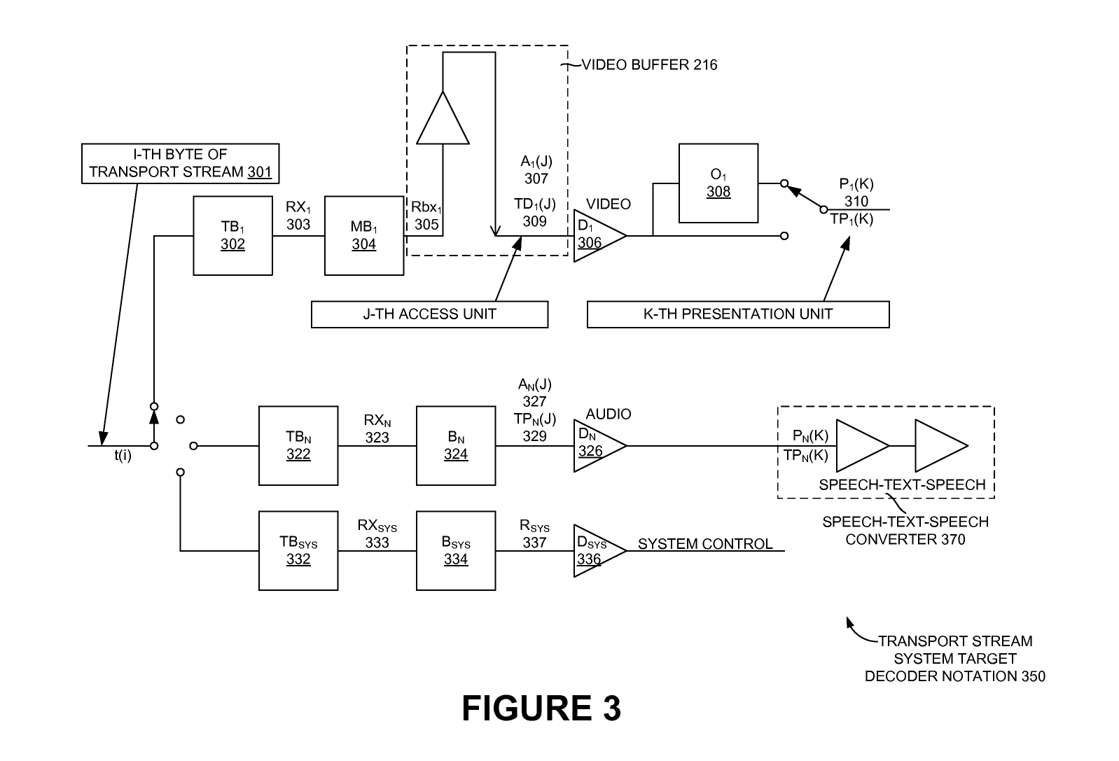

FIG. 3 is a schematic view illustrating a modified Transport stream-System Target Decoder (T-STD) 350 of ITU-T H.222 standard used herein for performing a decoding operation, according to one example embodiment. In one or more embodiments, the T-STD may be a decoder used for modeling the decoding process for the construction and/or verification of transport streams. As illustrated from FIG. 3, the T-STD decoder 350 may include three types of buffer models namely a video buffer model, an audio buffer model, and a system buffer model, according to one or more embodiments.

The video decoder may include a transport buffer TB₁ 302, a multiplexing buffer MB₁304, a video buffer 216, a video decoder unit 306 and a reorder buffer 308. The input to the T-STD may be a transport stream to communicate data. The transport stream may include multiple programs with independent time bases. However, in one embodiment, the T-STD may decode one program at a time. In one embodiment, data from the transport stream 301 may enter the T-STD at a piecewise constant rate. The input transport stream of the video signal 108 may be stored in the transport buffer TB₁302. The transport buffer TB₁302 may collect the incoming transport stream packets of the video signal 108 to communicate the transport stream of the video signal 108 at a uniform data rate. The transport stream of the video signal 108 may be communicated from the transport buffer TB₁302 to the multiplexing buffer MB₁ 304 at a rate of RX₁ 303. The multiplexing buffer MB₁ 304 may be used for storing payloads of the transport stream packets of the video signal 108. Further, the transport stream of the video signal 108 may be communicated from the multiplexing buffer MB₁ 304 to the video buffer 216 at a rate of Rbx₁ 305 to delay the transport stream of the video signal 108 to match the another audio signal 116. Further, an elementary stream of the video signal 108 (AO) 307) may be communicated from the video buffer 216 to the video decoder unit 306 in a specific decoding order for decoding the signal at a decoding time of TD₁(J) 309, where T is the access unit of the transport stream. Further, the decoded signal obtained from the video decoder unit 306 may be reordered through the reorder buffer 308 to obtain P₁(K) 310 before being presented at a TP₁(K) time. The term P₁(K) represents a K^{th} presentation unit and is obtained by decoding the A1(J).

Similarly, the audio buffer model may include a transport buffer TB_{N}322, an elementary stream multiplexing buffer MB_{N} 324, and an audio decoder unit D_{N}326. Complete transport stream packets containing data from elementary stream N, may be communicated to a transport buffer for stream ‘N’, TB_{N} 322. In one or more embodiments, transfer of the ‘I’^{th} byte from the T-STD input to TB_{N} 322 may be instantaneous, such that the I^{th} byte enters the buffer for stream N, of size TBS_{N}, at time t(I). In another embodiment, the PES (Packet Elementary Stream) packet of the elementary stream or PES contents may be delivered to the elementary stream multiplexing buffer MB_{N} 324 at a rate of RX_{N} 323. Further, ‘J’^{th} access unit of A_{N}(J) 327 is communicated at a decoding time of TP_{N}(J) 329 and decoded in the audio decoder unit D_{N} 326. Further, the decoded audio elementary stream may be provided to the speech-text-speech converter 370 for further processing as P_{N}(K), where ‘K’ represents K^{th} presentation unit.

Similarly, the system buffer model may include a transport buffer TB_{sys} 332, an elementary stream multiplexing buffer MB_{sys} 334, and a system decoder D_{sys}336. In one or more embodiments, complete transport stream packets containing system information, for the program selected for decoding, may enter the system transport buffer, TB_{sys}332, at the transport stream rate. Furthermore, elementary streams may be buffered in MB_{sys}334 at a rate of RX_{sys}333. Further, the elementary streams buffered in MB_{sys}334 may be decoded instantaneously by the system decoder D_{sys} 336 by extracting the elementary stream from the MB_{sys} 334 at a rate of R_{sys} 337. The decoded signals may be communicated to the system control.

In one or more embodiments, the function of a decoding system may be to reconstruct presentation units from compressed data and/or to present them in a synchronized sequence at the correct presentation times. Although real audio and/or visual presentation devices may have finite delays and/or additional delays imposed by post-processing or output functions, the system target decoder may modelthe delays as zero, according to one or more embodiment.

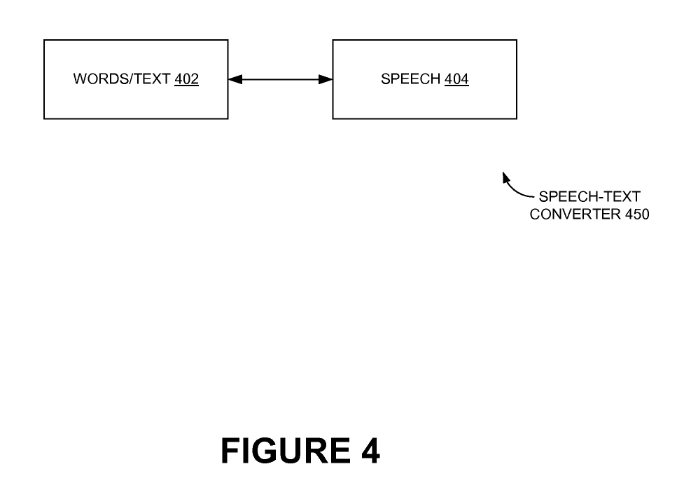

FIG. 4 is a schematic view of speech-to-text converter 450, according to one or more embodiments. The speech replacement module 102 may include the speech-to-text converter configured to convert the speech component 404 in the audio signal 106 into a text data 402. The speech component 404 of the audio signal 106 may be extracted. The extracted speech component may be analyzed for pitch, gain and format. Based on the pitch, the gain and/or format, the processor 104 may generate text information. In a text-to-speech conversion, the processor 104 may use avoice profile to convert the text data 402 into a speech data 404 as requested by the user 140.

FIG. 5 is a table view illustrating a portion of a database of speech 550, according to one example embodiment. The database may be configured to store one or more voice profiles. Each of the voice profiles may be provided with a unique speech ID and stored in a specific location in the database. These speech profiles may be selected by the user 140 using a personality name as illustrated through a request. An example illustrating a location of voice profile in a form of table is illustrated in FIG. 5. In particular, FIG. 5 illustrates a speech ID 502 field, the speech of the individual 504 field and/or the word/text file address 506 field, according to one or more embodiments. The speech ID 502 field may provide a unique speech ID information associated with a specific individual. The speech of the individual 504 field may provide voice profile information of an individual. The word/text file address 506 field may provide a location address of the voice profile and/or text file associated with the individual in the database of the processor 104.

In one example embodiment, first row of the table view provides an information about a voice profile of Howard Cossel with a speech ID 5 and stored in partition “F” (F://read/1972 Olympics Solomon Finals). In another example embodiment, second row provides information about a text data in a Spanish language located in partition “F” (F://read/microsoft word help).

The user 140 may select any voice profile for substitution. An example is provided herein to explain operations of the processor 104 for providing speech substitution. In one example embodiment, a sports media channel (e.g., the multimedia source 110) may broadcast a sports program. The sports program may be an audio-visual program that includes a real-time video of a sporting event, a speech commentary and textual commentary. The sports program may be delivered to theoutput device 120 through the processor 104. The commentator voice being presented in the sports program may be a voice of a commentator, for example, John Doe. At some instance of time, the user 140 of the client device 130 may request for change in commentary voice. The user 140 may make the request through a user interface as illustrated as an example in FIG. 6. The request may be communicated to the processor 104. The speech replacement module 102 may receive the request through the input/output module 202. The original signal being transmitted to the output device 120 may be processed to decode the voice signal to extract speech content of the voice signal. Further, a transcript may be generated based on the speech content. The video buffer 216 of the speech replacement module 102 may delay the communication of the video signal 108. Further, a voice profile selected by the user 140 may be used for replacing the speech component in the voice signal. The voice profile may be used for converting the transcript generated into a speech and the generated speech may be merged in another audio signal 116 at an appropriate instant of time. Further, the modified audio signal may be synchronized and communicated with the video signal 108 at an appropriate instant of time to the output device 120.

FIG. 6 is a user interface view 650 illustrating a choice of voice substitutions being provided to the user 140 in the client device 130, according to one example embodiment. FIG. 6 illustrates the user 140 obtaining information from the processor 104 regarding the program being watched. In some embodiments, the user 140 may obtain information from the processor 104 by communicating a request to the processor 104 by providing details about a program and a channel in which program is being telecasted. Upon obtaining needed information, the user 140 may be enabled to request a change in commentator, change in language and other possible requests allowable by the processor 104.

According to the example embodiment, the user 140 may request a change in speech content of the multimedia presentation 122. The processor 104 may provide a set of voice profiles for the user 140 to select. In an example embodiment, the user 140 interface of client device 650 may provide an option of selecting a voice profile 602 of any commentators such as John Madden, Pat Summerall, Spanish Language Announcer as illustrated in FIG. 6. The user 140 may be enabled to select a voice profile 602 of a commentator in a list of commentator voice profiles. Further, upon selection of a voice profile, the processor 104 may provide the modified multimedia presentation that includes the speech component in the audio as requested by the user 140.

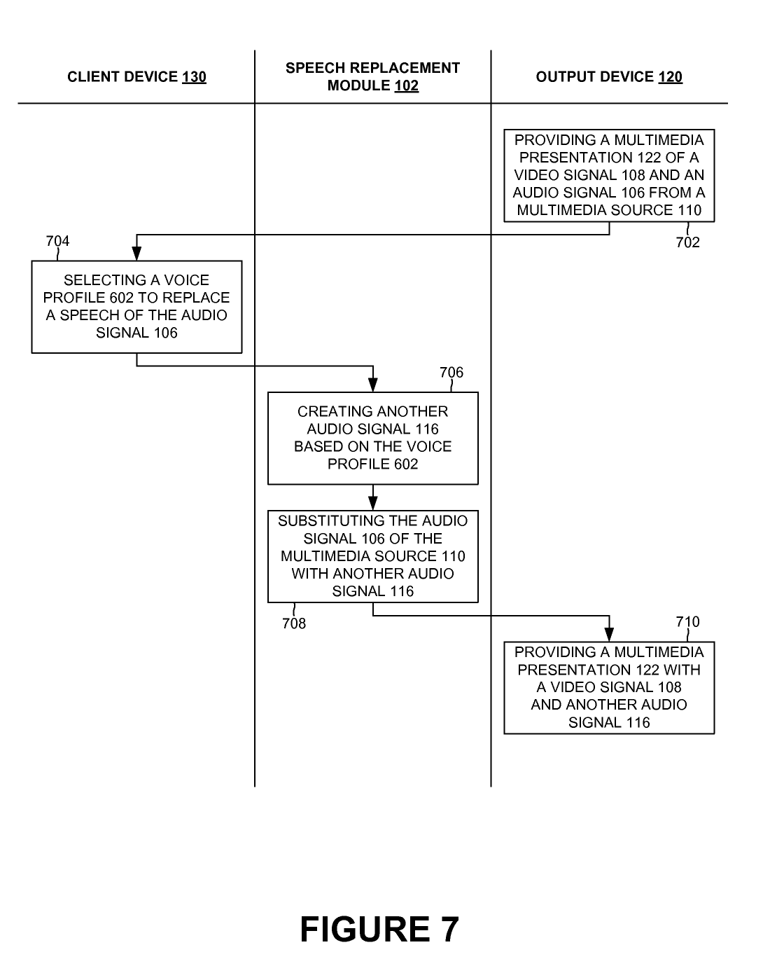

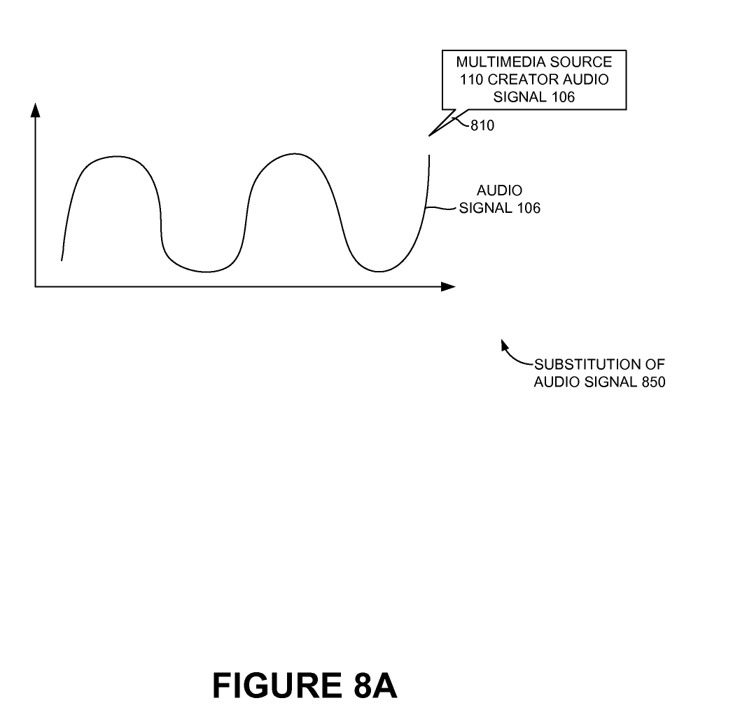

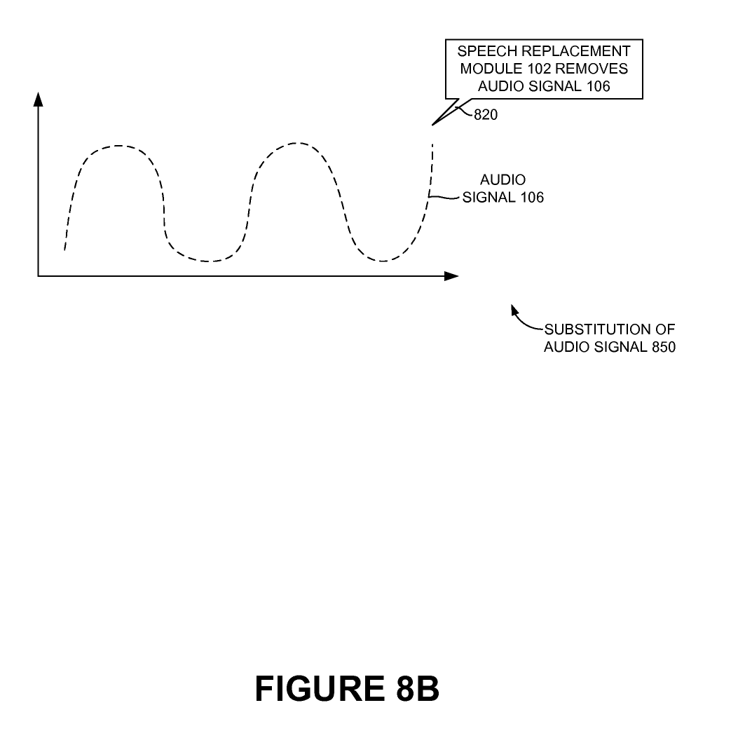

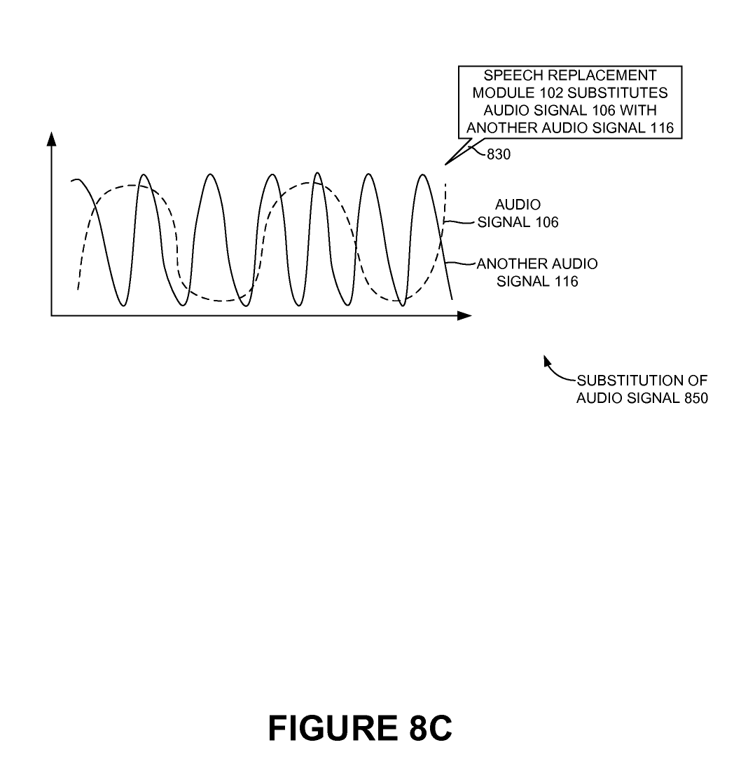

FIG. 7 is a flow diagram detailing operations involved in speech substitution of a real-time multimedia presentation 122, according to one or more embodiments. In operation 702, a multimedia presentation 122 of the video signal 108 and the audio signal 106 may be provided from the multimedia source 110 to the output device 120. A request of a user 140 may be obtained through the client device 130. In one embodiment, the request may be a request for change of voice profile. In operation 704, a voice profile 602 may be selected through the client device 130 to replace a speech of the audio signal 106. In operation 706, another audio signal 116 based on the requested voice profile 602 may be created through the speech replacement module 102. In operation 708, the audio signal 106 of the multimedia source 110 may be substituted with another audio signal 116 through the speech replacement module 102 (e.g., as illustrated in FIG. 8). Further, in operation 710, a multimedia presentation 122 may be provided with a video signal 108 and another audio signal 116.

FIGS. 8A, 8B and 8C are a schematic views illustrating substitution of an audio signal 106 with another audio signal 116, according to an example embodiment. FIG. 8A illustrates an example waveform associated with the audio signal 106. The audio signal 106 may be an original audio signal 106 generated through the multimedia source 110. FIG. 8B illustrates a removal operation of original audio signal 106 through the speech replacement module 102 to replace the original audio signal 106 with another audio signal 116. FIG. 8C illustrates a substitution of the audio signal 106 with another audio signal 116 through the speech replacement module 102.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any other combination of hardware, firmware, and software (e.g., embodied in a machine readable medium). For example, the various electrical structures and methods may be embodied using transistors, logic gates, and electrical circuits (e.g., application specific integrated (ASIC) circuitry and/or in Digital Signal Processor (DSP) circuitry).

What is claimed is:

1. A method comprising:
processing a multimedia signal of a multimedia presentation, using a processor, wherein the multimedia signal comprises a video signal and an audio signal, such that the audio signal is substitutable with another audio signal based on a preference of a user;
substituting the audio signal with the another audio signal based on the preference of the user;
permitting a selection of a voice profile during a real-time event based on a response to a request through a client device of the user;
creating the another audio signal based on the voice profile, wherein the voice profile is selected by the user;
delaying an output of the video signal to an output device of the user such that the video signal is synchronized with the another audio signal; and
processing the video signal and the another audio signal based on the voice profile such that the multimedia presentation is created based on the preference of the user.

2. The method of claim 1 wherein:
the voice profile is a voice font that has been programmed;
the voice font comprises a library of a speech; and
the library of the speech comprises at least one of a canned speech, a part of the speech of an individual of the voice profile, the speech of an impersonator of the individual of the voice profile, and the speech of a live commentator.

3. The method of claim 2 further comprising:
creating a text file based on the audio signal through a transcription of the speech of the audio signal;
creating the another audio signal based on the text file and the voice profile; and
substituting the audio signal with the another audio signal such that the audio signal is replaced with the another audio signal.

4. The method of claim 3 further comprising:
buffering the video signal such that the video signal is delayed;
delaying the video signal such that a conversion of the audio signal to the text file and the conversion of the text file to the another audio signal is completed during a delay of the video signal; and
synchronizing the another audio signal and the video through a delay of the video signal such that the another audio signal is matched with the video signal.

5. The method of claim 4 further comprising:
processing the audio signal such that a background noise is reduced; and
reducing the background noise such that a quality of the speech is increased.

6. The method of claim 5 further comprising:
creating the another audio signal based on the voice profile from the library of the speech, wherein the speech is one of a commentator speech, a celebrity speech, a foreign language speech, an impersonator speech, and a newscaster speech.

7. The method of claim 6 further comprising:
separating the audio signal and the video signal from the multimedia signal;
extracting the speech from the audio signal; and
coupling the another audio signal and the video signal such that the another audio signal and the video signal are synchronized.

8. The method of claim 7:
wherein the real-time event is a sporting event;
wherein the video signal is an image of the sporting event;
wherein the audio signal is the speech of a commentator of the sporting event;
wherein the another audio signal is the speech of another commentator;
wherein the speech of the another commentator is based on the voice profile; and
wherein the voice profile is based on the selection of the user.

9. The method of claim 7 further comprising:
translating the text file into a foreign language when the voice profile that is selected is a foreign language speaker; and
creating the another audio signal comprising the foreign language speech.

10. The method of claim 1 in the form of a machine-readable medium embodying a set of instructions that, when executed by a machine, cause the machine to perform the method of claim 1.

11. A method comprising:
obtaining video data together with first audio data, the first audio data including original speech data;
converting the original speech data to text data;
using a processor and without human intervention,
converting the text data to user-selected speech data,
combining a video data together with the user-selected speech data, and
providing the video data together with second audio data to be presented to a user, the second audio data including the user-selected speech data in place of the original speech data.

12. The method of claim 11, wherein:
the converting of the text data to the user-selected speech data includes obtaining a speech identifier from the user and using the speech identifier to convert the text data to the user-selected speech data.

13. The method of claim 12, wherein:
the speech identifier identifies at least one a user-selected person, a user-selected character, a user-selected accent, and a user-selected language, and wherein the user-selected speech data includes a vocalization of the text data characterized by the at least one of the user-selected person, the user-selected character, the user-selected accent, and the user-selected language.

14. The method of claim 13, wherein:
the converting of the original speech data to the text data includes transcribing the original speech data into transcription data, and the converting of the text data to the user-selected speech data includes
accessing a plurality of digital audio files associated with the at least one of the user-selected person, the user-selected character, the user-selected accent, and the user-selected language and the text data
arranging the plurality of digital audio files in a user selected speech data based on the transcription data.

15. The method of claim 11, wherein:
the converting of the original speech data to the text data includes processing the first audio data to isolate background noise from the original speech data so as to minimize error in a conversion of the original speech data to the text data.

16. The method of claim 11, wherein:
the combining of the video data together with the user-selected speech data is preceded by buffering the video data while converting the original speech data to the text data and converting the text data to the user-selected speech data.

17. A system comprising:
an output device to display a multimedia presentation;
a processor to process a multimedia signal of the multimedia presentation, wherein the multimedia signal comprises a video signal and an audio signal, such that the audio signal is substituted with another audio signal based on a preference of a user; and
a client device to permit a selection of a voice profile during a real-time event such that the another audio signal is based on the voice profile.

18. The system of claim 17 wherein:
the processor to substitute the audio signal with the another audio signal based on the preference of the user.

19. The system of claim 18 wherein:
the processor to delay an output of the video signal to the output device of the user such that the video signal is synchronized with the another audio signal.

20. The system of claim 19 wherein:
the processor to process the video signal and the another audio signal based on the voice profile such that the multimedia presentation is created based on the preference of the user.
